(19) United States
(12) Patent Application Publication
(10) Pub. No.: US 2014/0058042 A1
(43) Pub. Date: Feb. 27, 2014

(54) UNSATURATED POLYESTER RESIN COMPOSITION

(71) Applicants: Iris Hilker, Echt (NL); Johan Franz Gradas Antonius Jansen, Echt (NL); Nanning Joerg Arfsten, Echt (NL)

(72) Inventors: Iris Hilker, Echt (NL); Johan Franz Gradas Antonius Jansen, Echt (NL); Nanning Joerg Arfsten, Echt (NL)

(73) Assignee: DSM IP ASSETS B.V., Heerlen (NL)

(21) Appl. No.: 14/008,310

(22) PCT Filed: Mar. 29, 2012
(86) PCT No.: PCT/EP12/55674

§ 371 Date: Nov. 11, 2013

(30) Foreign Application Priority Data
Mar. 30, 2011 (EP) 11160440.1
Feb. 20, 2012 (EP) 12156142.7

(51) Int. Cl. C08F 8/16

(52) U.S. Cl. CPC C08F 8/16
USPC 525/245

(57) ABSTRACT

The present invention relates to an unsaturated polyester resin composition comprising (a) an unsaturated polyester, (b) a vinyl group containing organic compound as reactive diluent and (c) a transition metal compound, wherein the resin composition comprises (d) a compound according to formula (1) as reactive diluent

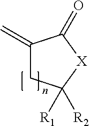

whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain or attached to a polymer chain,
and the composition comprises at least one transition metal compound (c) selected from the group consisting of Co, Cu, Mn and Fe compounds; and the resin composition comprises, as vinyl group containing organic compound (b), styrene, a styrene derivative, a vinyl ether, a vinyl amine, a vinyl amide or a mixture of at least two of these compounds

The present invention relates to an unsaturated polyester resin composition comprising (a) an unsaturated polyester, (b) a vinyl group containing organic compound as reactive diluent and (c) a transition metal compound as accelerator for the peroxide-initiated radical curing of the composition.

Such unsaturated polyester resin compositions are known in the art. For example, a composition comprising an unsaturated polyester diluted in styrene as reactive diluent and pre-accelerated with a transition metal like cobalt can be efficiently radical copolymerized (cured) with a peroxide. Styrene is often used as reactive diluent. Although styrene is a very effective reactive diluent, since styrene has a high copolymerization ability and a good cutting power (viscosity of the composition can be lowered efficiently when using styrene as comonomer), styrene has however an undesirable odour which is even more hindering since styrene is volatile. In view of this, there is a need to at least partly replace styrene by another reactive diluent with a good reactivity and good cutting power, but has less odour and/or is less volatile (i.e. has a higher boiling point). A standard replacement would be the use of high boiling methacrylate containing compounds. However, in general they have a reduced cutting power and furthermore they result in general in severe oxygen inhibition, i.e. upon curing in air, the surface remains tacky or even wet (uncured).

The object of the present invention is to provide a reactive diluent with less odour and/or being less volatile and with a good cutting power in unsaturated polyester resin compositions.

The object has surprisingly achieved in that the resin composition comprises (d) a compound according to formula (1) as reactive diluent

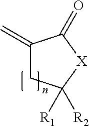

whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain or attached to a polymer chain,
and the composition comprises at least one transition metal compound (c) selected from the group consisting of Co, Cu, Mn and Fe compounds; and the resin composition comprises, as vinyl group containing organic compound (b), styrene, a styrene derivative, a vinyl ether, a vinyl amine or vinyl amide or a mixture of at least two of these compounds.

It has furthermore surprisingly been found that the reactive diluent according to formula (1) has a good copolymerization ability with the unsaturated polyester resin.

It has furthermore surprisingly been found that curing of the resin composition according to the invention with a peroxide can result in a higher glass transition temperature (T_{g}) and/or higher crosslink density of the cured network and thus that an improved cured network can be obtained.

It has surprisingly been found that curing of the composition according to the invention in the presence of air can be improved, in particular the tackiness of the air surface can be reduced and even tack free surfaces can be obtained.

An additional advantage of using compounds according to formula (1) is that they can be prepared from biobased raw materials.

The resin composition according to the invention comprises a compound (d) according to formula (1). Such compounds can be commercially obtained from for example TCI Europe and can be prepared with the method as described for example by Gary M. Ksander, John E. McMurry, and Mark Johnson, “A Method for the Synthesis of Unsaturated Carbonyl Compounds” in J. Org. Chem. 1977, vol. 42, issue 7, pages 1180-1185, or by Mitsuru Ueda and Masami Takahasi, “Radical-Initiated Homo- and Copolymerization of α-Methyl-γ-Butyrolactone” in J. Pol. Sci. A 1982, vol. 20, p. 2819-2828.

Preferably, n is 1 or 2. More preferably, n is 1. X is preferably O. Preferably, R₁ and R₂ each individually represent H or CH₃. More preferably, R₁ and R₂ are both H or R₁ is H and R₂ is CH₃. In a preferred embodiment of the invention, the composition comprises a compound (d) according to formula (2)

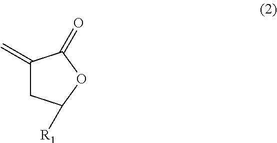

whereby R₁ is H or CH₃.

The resin composition according to the invention comprises a vinyl group containing organic compound (b) selected from the group consisting of styrene, styrene derivatives, vinyl ethers, vinyl amines, vinyl amides and mixtures of at least two of these compounds. Thus the resin composition may for example comprise, as vinyl group containing organic compound, styrene, or styrene and a vinyl ether, or two different vinyl ethers. In a preferred embodiment, the resin composition comprises styrene, a vinyl ether, a vinyl amine or vinyl amide or a mixture of at least two of these compounds as vinyl group containing organic compound. In a more preferred embodiment, the vinyl group containing organic compound is styrene, a vinyl ether, a vinyl amine or vinyl amide or a mixture of at least two of these compounds. In an even more preferred embodiment, the resin composition comprises styrene as vinyl group containing organic compound. In an even more preferred embodiment, the vinyl group containing organic compound is styrene.

Non-limited examples of styrene derivates are α-methyl styrene, vinyl toluene, 4-t.butylstyrene and 1,4-divinyl benzene. Non-limited examples of vinyl ethers are hydroxybutylvinylether, triethyleneglycoldivinylether and butanedioldivinylether. Non-limited examples of vinyl amides are N-vinylcaprolactam, N-vinylpyrrolidone and N-vinylformamide. Non-limited examples of vinyl amines are vinyl imidazole, dimethylvinylamine, N-vinylcarbazole.

The amount of unsaturated polyester (compound (a)) relative to the total amount of compounds (a), (b) and (d) is preferably from 20 to 80 wt. %, more preferably from 25 to 75 wt. %, even more preferably from 30 to 70 wt. % and most preferably from 35 to 65 wt. %. As used herein, the amount of compound (b) is the total amount of styrene, styrene derivatives, vinyl ethers, vinyl amines and vinyl amides.

The amount of compound (b) relative to the total amount of compounds (a), (b) and (d) is preferably from 10 to 50 wt. %, more preferably from 12 to 45 wt. %, even more preferably from 15 to 40 wt. % and most preferably from 18 to 35 wt. %.

The amount of compound (d) relative to the total amount of compounds (a), (b) and (d) is preferably from 5 to 60 wt. %, more preferably from 7 to 55 wt. %, even more preferably from 10 to 50 wt. % and most preferably from 12 to 45 wt. %.

The molar ratio of the amount of compound (b) to the amount of compound (d) is preferably from 0.1 to 10.

The resin composition according to the invention comprises a transition metal compound (c), dissolved in the mixture of unsaturated polyesters (a), the vinyl group containing organic compounds (b) and compounds (d) according to formula (1), and selected from the group consisting of Co, Cu, Mn, Fe compounds and any mixture thereof. More preferably, in view of curing efficiency, the resin composition comprises a transition metal compound (c) selected from the group consisting of Co, Cu, Mn compounds and any mixture thereof.

The Co compounds, Cu compounds, Fe compounds and Mn compounds are preferably salts and/or complexes. Preferably, the resin composition comprises a transition metal compound (c) selected from the group consisting of cobalt carboxylate, copper carboxylate, iron carboxylate, manganese carboxylate, cobalt acetylacetonate, copper acetylacetonate, iron acetylacetonate, manganese acetylacetonate, iron halide and any mixtures thereof. A preferred iron halide is iron chloride. More preferably the transition metal compound (c) is a cobalt carboxylate, a copper carboxylate, an iron carboxylate, a manganese carboxylate, a cobalt acetylacetonate, a copper acetylacetonate, an iron acetylacetonate, a manganese acetylacetonate, an iron halide or any mixture thereof. The carboxylate is preferably a C₁-C₃₀ carboxylate and more preferably a C₁-C₁₆ carboxylate.

The Co salt is preferably a Co²⁺ and/or a Co³⁺ salt. The Co complex is preferably a Co²⁺ and/or a Co³⁺ complex. The Cu salt is preferably a Cu⁺ and/or a Cu²⁺ salt. The Cu complex is preferably a Cu⁺ and/or a Cu²⁺ complex. The Mn salt is preferably a Mn²⁺ and/or a Mn³⁺ salt. The Mn complex is preferably a Mn²⁺ and/or a Mn³⁺ complex. The Fe salt is preferably a Fe²⁺ and/or a Fe³⁺ salt. The Fe complex is preferably a Fe²⁺ and/or a Fe³⁺ complex.

The total amount of Co, Cu, Mn and Fe compounds in the resin composition according to the invention is preferably such that the total amount of Co, Cu, Mn and Fe in mmol per kg of the sum of the amounts of compounds (a), (b) and (d) is preferably from 0.01 to 30, and more preferably from 0.1 to 20.

The resin composition may comprise a co-accelerator. Depending on the transition metal choice, the person skilled in the art will be able to choose an appropriate co-accelerator to obtain the desired curing characteristics. For example, in case a Co compound is used as transition metal compound, the co-accelerator is preferably an amine and/or a 1,3-dioxo compound. In case a Cu compound is used as transition metal compound, the co-accelerator is preferably an amine, acetoacetamide, a K salt, an imidazole and/or a gallate or mixtures thereof. In case a Mn compound is used as transition metal compound, the co-accelerator is preferably a 1,3-dioxo compound, a thiol and/or a K or Li salt or mixtures thereof. In case a Fe compound is used as transition metal compound, the co-accelerator is preferably a 1,3-dioxo compound and/or a thiol preferably in combination with an alkali metal salt. Non-limiting examples of 1,3-dioxo compounds are acetyl acetone, acetoacetates and acetoacetamides. The amount of co accelerator can vary within wide ranges and is preferably more than 0.01 wt. % and less than 10 wt. % preferably more than 0.1 wt. % and less than 5 wt. % (amount is given relative to the total amount of (a), (b) and (d)).

In one embodiment of the invention, the resin composition comprises a Co compound as transition metal compound and optionally a co-accelerator. The co-accelerator is preferably an amine and/or a 1,3-dioxo compound. In another embodiment of the invention, the resin composition comprises a Cu compound as transition metal compound and the resin composition preferably further comprises a co-accelerator preferably selected from an amine, an acetoacetamide, a K salt, an imidazole and/or a gallate or mixtures thereof. In still another embodiment of the invention, the resin composition comprises a Mn compound as transition metal compound and the resin composition preferably further comprises a co-accelerator preferably selected from a 1,3-dioxo compound, a thiol and/or a K or Li salt or mixtures thereof. In still another embodiment of the invention, the resin composition comprises a Fe compound as transition metal compound and the resin composition preferably further comprises a co-accelerator, the co-accelerator is preferably a 1,3-dioxo compound and/or a thiol preferably in combination with an alkali metal salt.

The unsaturated polyester refers to a thermosetting polymer prepared by the polycondensation of at least one or more diacids and diols and which polymer contains ethylenically unsaturated carbons. The unsaturation, typically, is introduced into the polyester by condensation with unsaturated diacids, such as for example maleic (typically used as the anhydride) or fumaric acids. Examples of suitable unsaturated polyester can be found in a review article of M. Malik et al. in J. M. S.—Rev. Macromol. Chem. Phys., C40 (2&3), p. 139-165 (2000). The authors describe a classification of such resins—on the basis of their structure—in five groups:
(1) Ortho-resins: these are based on phthalic anhydride, maleic anhydride, or fumaric acid and glycols, such as 1,2-propylene glycol, ethylene glycol, diethylene glycol, triethylene glycol, 1,3-propylene glycol, dipropylene glycol, tripropylene glycol, neopentyl glycol or hydrogenated bisphenol-A.
(2) Iso-resins: these are prepared from isophthalic acid, maleic anhydride or fumaric acid, and glycols.
(3) Bisphenol-A-fumarates: these are based on ethoxylated bisphenol-A and fumaric acid.
(4) Chlorendics: are resins prepared from chlorine/bromine containing anhydrides or phenols in the preparation of the UP resins.

The unsaturated polyester preferably comprises fumarate building blocks. The molar amount of fumarate building blocks in the unsaturated polyester (a) relative to the total molar amount of diacid building blocks in the unsaturated polyester (a) is preferably from 25% to 75%. The molar amount of fumarate building blocks in the unsaturated polyester (a) relative to the total molar amount of unsaturated dicarboxylic acid building blocks in the unsaturated polyester (a) is preferably equal to higher than 90%.

The resin composition preferably has an acid value in the range of from 0.01 to 100 mg KOH/g of resin composition, preferably in the range from 1 to 70 mg KOH/g of resin composition. In one embodiment, the resin composition has an acid value in the range of from 5 to 20. In another embodiment the resin composition has an acid value in the range of from 30 to 50. As used herein, the acid value of the resin composition is determined titrimetrically according to ISO 2114-2000.

The number-average molecular weight Mₙ of the unsaturated polyester is preferably in the range of from 500 to 200000 g/mole, more preferably from 750 to 5000 and more preferably from 1000 to 3000 g/mole. As used herein, the number-average molecular weight Mₙ of the unsaturated polyester is determined using gel permeation chromatography according to ISO 13885-1 using polystyrene standards.

The resin composition preferably further comprises a radical inhibitor. These radical inhibitors are preferably chosen from the group of phenolic compounds, benzoquinones, hydroquinones, catechols, stable radicals and/or phenothiazines. The amount of radical inhibitor that can be added may vary within rather wide ranges, and may be chosen as a first indication of the gel time as is desired to be achieved.

Suitable examples of radical inhibitors that can be used in the resin compositions according to the invention are, for instance, 2-methoxyphenol, 4-methoxyphenol, 2,6-di-t-butyl-4-methylphenol, 2,6-di-t-butylphenol, 2,4,6-trimethyl-phenol, 2,4,6-tris-dimethylaminomethyl phenol, 4,4′-thio-bis(3-methyl-6-t-butylphenol), 4,4′-isopropylidene diphenol, 2,4-di-t-butylphenol, 6,6′-di-t-butyl-2,2′-methylene di-p-cresol, hydroquinone, 2-methylhydroquinone, 2-t-butylhydroquinone, 2,5-di-t-butylhydroquinone, 2,6-di-t-butylhydroquinone, 2,6-dimethylhydroquinone, 2,3,5-trimethylhydroquinone, catechol, 4-t-butylcatechol, 4,6-di-t-butylcatechol, benzoquinone, 2,3,5,6-tetrachloro-1,4-benzoquinone, methylbenzoquinone, 2,6-dimethylbenzoquinone, napthoquinone, 1-oxyl-2,2,6,6-tetramethylpiperidine, 1-oxyl-2,2,6,6-tetramethylpiperidine-4-ol (a compound also referred to as TEMPOL), 1-oxyl-2,2,6,6-tetramethylpiperidine-4-one (a compound also referred to as TEMPON), 1-oxyl-2,2,6,6-tetramethyl-4-carboxyl-piperidine (a compound also referred to as 4-carboxy-TEMPO), 1-oxyl-2,2,5,5-tetramethylpyrrolidine, 1-oxyl-2,2,5,5-tetramethyl-3-carboxylpyrrolidine (also called 3-carboxy-PROXYL), galvinoxyl, aluminium-N-nitrosophenyl hydroxylamine, diethylhydroxylamine, phenothiazine and/or derivatives or combinations of any of these compounds.

Advantageously, the amount of radical inhibitor in the resin composition according to the invention (relative to the total amount of resin composition). is in the range of from 0.0001 to 10% by weight. More preferably, the amount of inhibitor in the resin composition is in the range of from 0.001 to 1% by weight. The skilled man quite easily can assess, in dependence of the type of inhibitor selected, which amount thereof leads to good results according to the invention.

The unsaturated polyester resin composition according to the invention may further comprise (in)organic filler. The amount of (in)organic filler relative to the total amount of compounds (a), (b) and (d) is preferably from 10 to 90 wt. %. Preferably, the unsaturated polyester resin composition comprises fibre as filler. Suitable fillers are aluminium trihydrate, calcium carbonate, mica, glass, microcrystalline silica, quartz, barite and/or talc. These fillers may be present in the form of sands, flours or molded objects, especially in the form of fibers or spheres. Examples of fibres are glass fibres and carbon fibres.

The present invention further relates to a process for radically curing a resin composition according to the invention whereby the curing is effected in the presence of a peroxide selected from the group consisting of hydroperoxides, perketals, peresters, percarbonates and mixtures thereof. The amount of peroxide relative to the total amount of compounds (a), (b) and (d) is preferably from 0.01 to 30 wt. %, more preferably from 0.05-20 wt. % and even more preferably from 0.1-15 wt. %. The curing is effected preferably at a temperature in the range of from −20 to +150° C., more preferably in the range of from −20 to +100° C. and even more preferably in the range of from −20 to +40° C.

The present invention further relates to a multicomponent system comprising (a) an unsaturated polyester, (b) styrene, a styrene derivative, a vinyl ether, a vinyl amine or vinyl amide or a mixture of at least two of these compounds as a vinyl group containing organic compound (b), (c) a transition metal compound as accelerator, a peroxide and (d) a compound according to formula (1) as reactive diluent

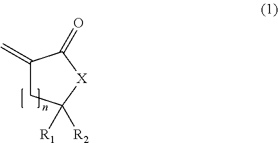

whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain or attached to a polymer chain, and the system comprises at least one transition metal compound (c) selected from the group consisting of Co, Cu, Mn and Fe compounds; and at least one peroxide selected from the group consisting of hydroperoxides, perketals, peresters and percarbonates.

Preferred compounds (a), (b), (c) and (d) as well as the amounts are as described above. The system may further comprise additional compounds such as a radical inhibitor in amounts as described above.

The use of the multicomponent system according to the invention requires mixing of at least the compounds (a), (b), (c) and (d) together with the peroxide selected from the group consisting of hydroperoxides, perketals, peresters, percarbonates and mixtures thereof to obtain a cured network. As used herein, multicomponent systems means a system with at least two spatially separated components whereby the peroxide is present in one component that does not comprise radical copolymerizable compounds including compounds (a), (b) and (d) in order to prevent premature radical copolymerization of the compounds (a), (b) and (d) prior to the use of the multicomponent system to obtain the cured network. At the moment that the radically copolymerization of the compounds (a), (b) and (d) is desired, at least a peroxide as described above is added to this composition. Preferably, said adding is done by mixing the peroxide into the composition comprising compounds (a), (b) and (d). The multicomponent system according to the invention comprises at least two components.

In one embodiment, the multicomponent system comprises at least three components I, II and III, whereby component I consists of a composition comprising compounds (a), (b) and (d), component II consists of a composition comprising compound (c) and component III comprises the peroxide.

In another embodiment, the system comprises at least two components I and II, whereby component I consists of a composition comprising compounds (a), (b), (c) and (d) and component II comprises the peroxide.

The present invention further relates to a two component system consisting of a first component I and a second component II, the first component I is a resin composition as defined above and the second component II comprises a peroxide selected from the group consisting of hydroperoxides, perketals, peresters, percarbonates and mixtures thereof.

Very suitable examples of hydroperoxides are tert-butyl hydroperoxide and cumene hydroperoxide. Preferred perketals are the addition products of hydrogen peroxide with a ketone. Very suitable examples of such perketals are methyl ethyl keton peroxide and acetylacetonperoxide. A very suitable example of perester is tert-butyl perbenzoate. A very suitable example of percarbonate is for instance tert-butyl peroxy ethylhexylcarbonate. The skilled man quite easily can assess, in dependence of the type of transition metal compound selected, which peroxide leads to good results according to the invention. The peroxide is preferably a hydroperoxide, a perester and/or a perketal as these peroxides have a higher thermal stability than percarbonates.

The present invention further relates to cured objects obtained by curing the resin composition according to the invention with a peroxide selected from the group consisting of hydroperoxides, perketals, peresters, percarbonates and mixtures thereof, or obtained by the process according to the invention or obtained by mixing the compounds of the multicomponent system as described above.

The present invention further relates to the use of such a cured structural part in automotive, boats, chemical anchoring, roofing, construction, containers, relining, pipes, tanks, flooring or windmill blades.

The invention is now demonstrated by means of a series of examples and comparative examples. All examples are supportive of the scope of claims. The invention, however, is not restricted to the specific embodiments as shown in the examples.

### GEL TIMER EXPERIMENTS

In some of the Examples and Comparative Experiments presented hereinafter, it is mentioned that curing was monitored by means of standard gel time equipment. This is intended to mean that both the gel time (T_{gel} or T_{25->35° C.}) and peak time (Tₚₑₐₖ or T_{25->peak}) and peak temperature were determined by exotherm measurements according to the method of DIN 16945 when curing the resin with the peroxides as indicated in the Examples and Comparative Examples. The equipment used therefore was a Soform gel timer, with a Peakpro software package and National Instruments hardware; the waterbath and thermostat used were respectively Haake W26, and Haake DL30.

### Example 1 and Comparative Experiments A1-A4

To 33.1 g Palatal P5-01 (an unsaturated polyester in styrene, DSM Composite Resins) and 14.4 g of various monomers was added 210 mg NL-49-P (a 1% Co solution, Akzo Nobel). Of these mixtures the viscosity was determined (Brookfield CAP 1000, 25 C 750 rpm, cone 1). To these mixtures 420 mg Trigonox 44B (a perketal, Akzo Nobel) was added. 12 g of the mixture was poured in an Al dish for the determination of Barcol hardness of a 4 mm casting. Furthermore of 25 g the curing was monitored in the standard gel timer equipment. Barcol hardness was measured according to DIN EN 59.

The results are shown in table 1.

TABLE 1

| | | | | Gel | Peak | Peak | Barcol | Barcol |
|---|---|---|---|---|---|---|---|---|
| | | Boiling point | Viscosity | time | time | temp | hardness | hardness |
| | Monomer | (° C./mmHg) | (Pa · s) | (min) | (min) | (° C.) | top | bottom |
| Example 1 | MBL | 88/12 | 0.089 | 32.2 | 43 | 171 | 18 | 26 |
| Comp A1 | Sty | 145/760 | 0.184 | 15.9 | 26.4 | 154 | 23 | 23 |
| Comp A2 | LMA | 142/4 | no | | | | | |
| | | | mixing | | | | | |
| Comp A3 | HPMA | 57/0.5 | 0.489 | 44.8 | 55.8 | 149 | tacky | Tacky |
| | | | (cone 2) | | | | | |
| Comp A4 | MMA | 100/760 | 0.099 | 69.6 | 79.3 | 171 | tacky | Tacky |

MBL = α-methylene butyrolactone
Sty = styrene
LMA = lauryl methacrylate
HPMA = 2-hydroxypropyl methacrylate
MMA = methyl methacrylate

This example and the comparative experiments clearly show that the reactive diluents according to the invention are well suited to be used in unsaturated polyesters with styrene. It exhibits a very good cutting power (indicated by the low viscosity), a low volatility (indicated by the high boiling point), a good curing (indicated by the high peak temperature) a good curing in air (indicated by hardness at the top of the casting).

The very good curing in air is very surprising in light of the results obtained with MMA (which has a similar molecular weight Mn).

The castings of Example 1 and comparative experiment A1 were subjected to DMA analysis according to ASTM D5026. The results are:

### Comp A1: Modulus @23° C.: 3122 MPa; T_{g} 100° C.

### Example 1: Modulus @23° C.: 4014 MPa; T_{g} 102° C.

These results indicate a better formation of the x-linked network using a compound according to formula (1).

### Comparative Experiment A5

Styrene was evaporated from Palatal P5-01, thereafter MBL was added. IR analysis showed that no curing of the unsaturated polyester was observed and that only polymerization of MBL has taken place.

Comparing example 1 with comparative experiment A1 and A5 shows that an unexpected synergistic effect on mechanical properties can be obtained when using the formulation according to the invention:

In comparative experiment A1, in which only styrene is present as reactive diluent, a cured network is obtained with a certain modulus;

In comparative experiment A5, in which only MBL is present as reactive diluent, no cured network at all was detected by IR analysis;

In example 1, in which MBL and styrene are present as reactive diluent, a cured network with a modulus that is significantly higher than in comparative experiment A1 is obtained.

### Example 2 and Comparative Experiments B1-B4

To 30.5 g Synolite 8388 (an unsaturated DCPD containing polyester in styrene, DSM Composite Resins) and 11.5 g of various monomers was added 1.2 g NL-49-P (a 1% Co solution, Akzo Nobel). Of these mixtures the viscosity was determined (Brookfield CAP 1000, 25 C 750 rpm, cone 1). To these mixtures 840 mg Butanox M50 (a perketal, Akzo Nobel) was added. 12 g of the mixture was poured in an Al dish for the determination of Barcol hardness of a 4 mm casting. Furthermore of 25 g the curing was monitored in the standard gel timer equipment. The results are shown in table 2.

TABLE 2

| | | | | Gel | Peak | Peak | Barcol | Barcol |
|---|---|---|---|---|---|---|---|---|
| | | Boiling point | Viscosity | time | time | temp | hardness | hardness |
| | Monomer | (° C./mmHg) | (Pa · s) | (min) | (min) | (° C.) | top | bottom |
| Ex 2 | MBL | 88/12 | 0.085 | 13.8 | 28.6 | 163 | 17 | 15 |
| Comp B1 | Sty | 145/760 | 0.06 | 7.3 | 29.2 | 131 | 5 | 3 |
| Comp B2 | LMA | 142/4 | no | | | | | |
| | | | mixing | | | | | |
| Comp B3 | HPMA | 57/0.5 | 0.162 | 18.3 | 40.7 | 125 | Slightly | 22 |
| | | | | | | | tacky | |
| Comp B4 | MMA | 100/760 | 0.093 | 13.4 | 25.3 | 165 | Slightly | 30 |
| | | | | | | | tacky | |

Again this example and the comparative experiments clearly show that the reactive diluents according to the invention are well suited to be used in various unsaturated polyesters with styrene. It exhibits a very good cutting power (indicated by the low viscosity), a low volatility (indicated by the high boiling point), a good curing (indicated by the high peak temperature) and a good curing in air (indicated by hardness at the top of the casting).

### Example 3-4 and Comparative Examples C1-C4

To 33.1 g Palatal P5-01 (an unsaturated polyester in styrene, DSM Composite Resins) and 11.9 g of MBL was added 210 mg of various metal solutions and optionally x g of co-accelerator (obtained from Aldrich). (see table 3). Next to these mixtures 420 mg peroxide (see table 3) was added. The curing of 25 g of this mixture was monitored in the standard gel timer equipment. The results are shown in table 3.

TABLE 3

| | | Active | | | Gel | Peak | Peak |
|---|---|---|---|---|---|---|---|
| | | transition | | | time | time | temp |
| | Metal solution | metal | Further additives | Peroxide | (min) | (min) | (° C.) |
| 3 | NL-49P | Co | | Trigonox | 34.4 | 45.6 | 168 |
| | | | | 44B | | | |
| 4 | Nuodex Cu-8 | Cu | 0.4 g N.N-diethyl | Butanox | 281.8 | 301.2 | 106 |
| | (obtained from | | acetoacetamide/ | M50 | | | |
| | Rockwood) | | 0.4 g Koctanoate | | | | |
| C1 | Nuodex Zr-8 | Zr | | Butanox | No | | |
| | (obtained from | | | M50 | cure | | |
| | Rockwood) | | | | | | |
| C2 | Octasoligen | Zn | | Butanox | No | | |
| | Zn-12 (obtained | | | M50 | cure | | |
| | from OMG) | | | | | | |
| C3 | Nuodex Ca-5 | Ca | | Butanox | No | | |
| | (obtained from | | | M50 | cure | | |
| | Rockwood) | | | | | | |
| C4 | Potassium 2- | K | | Butanox | No | | |
| | ethylhexanoate | | | M50 | cure | | |
| | (15% K in solvents) | | | | | | |
| | (obtained from | | | | | | |
| | Rockwood) | | | | | | |

These examples combined with the comparative experiments demonstrate that curing can be effected by using the transition metals according to the invention in combination with various peroxides.

### Example 5-6

Example 4 was repeated except that 210 mg of Octasoligen Mn-10 (obtained from OMG) respectively Nuodex Fe-12 (obtained from Rockwood) was used as metal solution. Next to these mixtures 420 mg of Butanox M50 was added. After 24 h, also a hard cured object was obtained.

1. An unsaturated polyester resin composition comprising (a) an unsaturated polyester, (b) a vinyl group containing organic compound as reactive diluent and (c) a transition metal compound, wherein the resin composition comprises (d) a compound according to formula (1) as reactive diluent 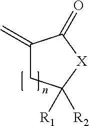
whereby n=0-3; R₁ and R₂ each individually represent H, C₁-C₂₀ alkyl, C₃-C₂₀ cycloalkyl, C₆-C₂₀ aryl, C₇-C₂₀ alkylaryl or C₇-C₂₀ arylalkyl; X=O, S or NR₃ whereby R₃=H, C₁-C₂₀ alkyl, C₃-C₂₀ cycloalkyl, C₆-C₂₀ aryl, C₇-C₂₀ alkylaryl, C₇-C₂₀ arylalkyl, part of a polymer chain and/or attached to a polymer chain, and the composition comprises at least one transition metal compound (c) selected from the group consisting of Co, Cu, Mn and Fe compounds; and the resin composition comprises, as vinyl group containing organic compound (b), styrene, a styrene derivative, a vinyl ether, a vinyl amine, a vinyl amide or a mixture of at least two of these compounds.

2. Unsaturated polyester resin composition according to claim 1, wherein compound (d) is according to formula (2). 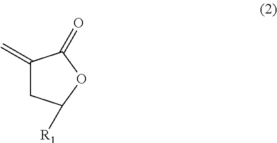
whereby is R₁ is H or CH₃.

3. Unsaturated polyester resin composition according to claim 1 wherein the resin composition comprises styrene as vinyl group containing organic compound (b).

4. Unsaturated polyester resin composition according to claim 1, wherein the amount of unsaturated polyester (compound (a)) relative to the total amount of compounds (a), (b) and (d) is from 20 to 80 wt. %, whereby the amount of compound (b) is the total amount of styrene, styrene derivatives, vinyl ethers, vinyl amines and vinyl amides.

5. Unsaturated polyester resin composition according to claim 1, wherein the amount of compound (b) relative to the total amount of compounds (a), (b) and (d) is from 10 to 50 wt. %, whereby the amount of compound (b) is the total amount of styrene, styrene derivatives, vinyl ethers, vinyl amines and vinyl amides.

6. Unsaturated polyester resin composition according to claim 1, wherein the amount of compound (d) relative to the total amount of compounds (a), (b) and (d) is from 5 to 60 wt. %.

7. Unsaturated polyester resin composition according to claim 1, wherein the molar ratio of the amount of compound (b) to the amount of compound (d) is from 0.1 to 10.

8. Unsaturated polyester resin composition according to claim 1, wherein the resin composition comprises a transition metal compound (c) which is at least one selected from the group consisting of Co, Cu, and Mn compounds.

9. Unsaturated polyester resin composition according to claim 1, wherein the Co compounds, Cu compounds, Fe compounds and Mn compounds are salts and/or complexes.

10. Unsaturated polyester resin composition according to claim 1, wherein the total amount (in mmol) of Co, Cu, Mn and Fe compounds (relative to the total amount (in kilogram) of compound (a), (b) and (d)) is from 0.01 to 30.

11. Unsaturated polyester resin composition according to claim 1, wherein the resin composition further comprises a co-accelerator.

12. Unsaturated polyester resin composition according to claim 1, wherein the unsaturated polyester comprises fumarate building blocks.

13. Unsaturated polyester resin composition according to claim 1, wherein the unsaturated polyester (a) comprises fumarate building blocks and the molar amount of fumarate building blocks in the unsaturated polyester (a) relative to the total molar amount of diacid building blocks in the unsaturated polyester (a) is from 25% to 75%.

14. Process for radically curing a resin composition according to claim 1, comprising curing in the presence of at least one peroxide selected from the group consisting of hydroperoxides, perketals, peresters, and percarbonates.

15. Cured object obtained by curing the resin composition according to claim 1 with at least one peroxide selected from the group consisting of hydroperoxides, perketals, peresters, and percarbonates.

16. A cured object of claim 15 capable of being used in automotive, boats, chemical anchoring, roofing, construction, containers, relining, pipes, tanks, flooring and/or windmill blades.
